(19) United States
(12) Patent Application Publication
(10) Pub. No.: US 2007/0099454 A1
(43) Pub. Date: May 3, 2007

(54) Medicament container

(76) Inventor: James Gordon, Redditch (GB)

Correspondence Address: Gunnar G Leinberg;Nixon Peabody, Clinton Square, P O Box 31051, Rochester, NY, 14603-1051, US

(21) Appl. No.: 10/557,946

(22) PCT Filed: May 24, 2004
(86) PCT No.: PCT/GB04/02234

§ 371 Date: Dec. 27, 2006

(30) Foreign Application Priority Data
May 24, 2003 (GB) 0312007.8

(51) Int. Cl. H01R 13/648

(52) U.S. Cl. 439/107

(57) ABSTRACT

Receptacle and delivery system for drugs delivered by powder inhalation and a method related thereto which provides improved entrainment, deagglomeration and/or aerosolisation of the powder. The receptacle (1) for holding a medicament comprises a cavity provided with a raised ridge (6, 22) which is adapted so that, in use, the airflow (in particular the inlet air or flushing air within the receptacle) is split into two substantially equal parts, e.g. providing first and second reservoirs.

This invention relates to a novel form of drug container and/or a method of drug delivery and to medical devices and methods of treatment utilising such containers and/or methods.

Conventionally known powder inhalation devices comprise a medicament housed in a foil covered blister. In use, the foil and the blister are both ruptured, allowing the powdered medicament to be blown or sucked out. However, such systems suffer from the disadvantage that, inter alia, powdered medicament can be entrapped in or around the ruptured foil or in the blister space. This can lead to a patient receiving an inconsistent dosage of medicament.

U.S. Pat. No. 4,778,054 describes a blister pack, e.g. for housing a powdered medicament, which overcomes or mitigates the disadvantages experienced with prior art blister packs by regulating the ratio of the diameter to depth of each of the blisters.

U.S. Pat. No. 5,921,237 to Dura, describes an inhaler comprising a rotatably mounted blister pack disk with means adapted to shear open a sealed blister and thereby deliver the drug dose to the patient.

International Patent Application No. WO 01/43529—Inhale describes a receptacle for holding fine powders wherein the bottom end of the receptacle is provided with a raised central region that extends upwardly in the cavity of the receptacle. In particular, Inhale describes at page 10, lines 15 to 17 a receptacle which comprises, inter alia, a continuously curved wall that forms a raised central region at or near the centre of the receptacle. In use, a powder extraction tube is inserted into the receptacle adjacent or above the raised central region so that a laminar flow occurs and a shear stress is created along the length of the walls of the receptacle.

Thus, there has long been a need for an improved inhalation system which, in particular, is efficient in emptying a powder receptacle and maximising the effect of the air flow in aerosolising the powder.

It is an aim of embodiments of the present invention to at least partly mitigate the above-mentioned problems.

A novel receptacle and a novel delivery system have been developed, e.g. a powder delivery system, and a novel method related thereto which provide improved entrainment, deagglomeration and/or aerosolisation of the powder.

In particular, we have surprisingly found a novel receptacle which, comprises a raised diametrical portion and which, in use, is adapted to create laminar flow and shear stress by splitting the air flow into two substantially equal portions.

Thus, according to the invention a first aspect of the present invention there is provided a receptacle for holding a medicament, the receptacle comprising a cavity provided with a raised ridge.

It will be understood by one skilled in the art that the reference to a “ridge” is intended to be distinct from the raised central portion described in WO 01/43529.

The ridge is adapted so that, in use, the air flow, in particular the inlet air or flushing air within the receptacle, is split into two substantially equal parts, e.g. providing first and second reservoirs. Thus, the diametrical ridge may be such that the length of the ridge is equivalent to the internal diameter of the receptacle. However, it is within the scope of the invention for the length of the ridge to be less than the length of the internal diameter of the receptacle.

It may be, for example, a radial ridge, that is, a ridge which traverses the radius of the receptacle, or the ridge may traverse a region of the receptacle without contacting the walls of the receptacle. In a further embodiment the ridge, e.g. a radial ridge, may be arcuate, for example, such that the height of the ridge is greater towards the periphery of the receptacle than it is adjacent the middle of the receptacle. This aspect of the invention is advantageous in that, inter alia, two vortices are caused along the length of the receptacle. However, in a preferred aspect of the invention, the ridge is substantially diametrical.

The height of the ridge may vary. Thus the height of the ridge may be such that the ridge extends up to the top of the receptacle. However, the ridge will not protrude above the receptacle. Alternatively, the upper surface of the ridge may lie below the top of the receptacle. A ridge which lies beneath the top of the receptacle is preferred so that in use, if desirable, a vent tube and/or inlet tube may be inserted into the receptacle substantially above the ridge.

In the method of the invention the raised region acts as a splitter ridge and the gas jet directed at the raised region is divided into two substantially equal portions and after flowing around the edges of the receptacle leaves the receptacle at substantially the same velocity as it entered.

According to a further aspect of the invention we provide an apparatus adapted for the entrainment, and/or aerosolisation of a medicament which comprises a housing having a holder that is adapted to receive a receptacle as hereinbefore described.

In a preferred aspect of the invention the medicament is a powder and the apparatus is adapted for entrainment, deagglomeration and aerosolisation of the powder.

The receptacle will generally be provided with a cover, e.g. a frangible sealing member, such as a foil strip. Preferably, the apparatus also comprises a piercing mechanism that is adapted to pierce a hole in the receptacle cover. Preferably the piercing mechanism is adapted to pierce a hole in the top of this cover, that is, away from the base of the receptacle. Alternatively, the apparatus may comprise means for complete or partial removal of the cover. The apparatus may also include an extraction tube, e.g. a powder extraction tube, that is adapted to be placed into the receptacle after the cover has been pierced or removed. The extraction tube may itself act as the piercing member or a separate piercing member and extraction tube may be provided. In use the extraction tube may be positioned above the diametrical ridge, although it is within the scope of the present invention that the extraction tube may be displaced from the ridge.

In the embodiment of the invention in which the ridge is a substantially radial ridge, the vent tube is preferentially placed substantially above the ridge, whilst the extraction tube is preferentially placed remote from the ridge, i.e. substantially coaxial with the ridge, but in the ridgeless region of the receptacle.

Furthermore, in addition to the piercing mechanism, the apparatus may include a vent forming mechanism, e.g. for forming a vent, i.e. an air or gas inlet, or multiple vents, in the top end of the receptacle.

According to a further aspect of the present invention there is also provided a plurality of dosage units arranged in series, each unit being as hereinbefore and/or hereinafter described. The units may be releasably or permanently attached to one another so as to be in a chain-like conformation, preferably a flexible or semi-flexible chain. The design of dosage units in accordance with the invention makes such flexibility possible.

A series of dosage units in accordance with this aspect of the invention is advantageous for use in an inhaler, because it allows sequential presentation of doses of a medicament to the inhalation passage of the inhaler as the series is indexed through the inhaler. If the series is in the form of a flexible chain, it can then be rolled or folded up for compact storage in the inhaler. The series may be of any appropriate length. It may, for instance, be supplied in a length greater than might be needed for use in an inhaler, but capable of being broken up into usable lengths. In an especially preferred embodiment the plurality of dosage units are contained in a cartridge and such a cartridge forms a further aspect of the invention.

According to a still further aspect of the present invention there is also provided a medicament delivery device comprising a dosage unit as hereinbefore described. The medicament may, for example, be a powder or a liquid. In a most preferred embodiment the medicament is a powder and therefore, preferably, the delivery device is a delivery device, such as an inhaler, e.g. a dry powder inhaler.

Thus, according to a further feature of embodiments of the present invention we provide an inhaler comprising medicament and a dosage unit as hereinbefore described. We especially provide a dry powder delivery device. In a further embodiment we provide an inhaler as hereinbefore described comprised a plurality of medicament dosage units.

When the medicament delivery device comprises an inhaler the medicament channel of the rupturing member may comprise an air channel and/or an aerosolisation channel. Whilst, generally, the medicament/air channel in the rupturing member is adapted for the removal of medicament, e.g. in aerosolised form, from the metering member, it may also be used to introduce, e.g. flushing air in the receptacle.

In the inhaler of the invention the medicament dosage units are preferably presented in a cartridge as hereinbefore described.

The term dry powder should be construed as meaning a variety of aerosolisable materials, thus, for example, conventional powders, spray dried materials, such as granules, etc.

The receptacle of the invention is preferentially adapted to be a drug reservoir, e.g. housing a powdered medicament. A variety of medicaments may be administered by using the inhaler of the invention. Such medicaments are generally suitable for the treatment of asthma, COPD and respiratory infections. Such medicaments include, but are not limited to β₂-agonists, e.g. fenoterol, formoterol, pirbuterol, reproterol, rimiterol, salbutamol, salmeterol and terbutaline; non-selective beta-stimulants such as isoprenaline; xanthine bronchodilators, e.g. theophylline, aminophylline and choline theophyllinate; anticholinergics, e.g. ipratropium bromide; mast cell stabilisers, e.g. sodium cromoglycate and ketotifen; bronchial anti-inflammatory agents, e.g. nedocromil sodium; and steroids, e.g. beclomethasone dipropionate, fluticasone, budesonide, flunisolide and ciclesonide, and isomers and/or salts or derivatives thereof.

Specific combinations of medicaments which may be mentioned include combinations of steroids, such as, beclomethasone dipropionate and formoterol; beclomethasone dipropionate and salmeterol; fluticasone and formoterol; fluticasone and salmeterol; budesonide and formoterol; budesonide and salmeterol; flunisolide and formoterol; and flunisolide and salmeterol. It is also within the scope of this invention to include combinations of one or more of the aforementioned steroids with one or more of the aforementioned β₂-agonists. When the receptacle of the invention is used in conjunction with a combination therapy as hereinbefore described, each of the first and second reservoir may hold a combination therapy. However, in one option of the invention, the first reservoir may contain a first medicament and the second reservoir may contain a second medicament.

Further medicaments which may be mentioned include systemically active materials, such as, proteinaceous compounds and/or macromolecules, for example, hormones and mediators, such as insulin, human growth hormone, leuprolide and alpha interferon; growth factors, anticoagulants, immunomodulators, cytokines and nucleic acids.

According to a still further aspect of the present invention we provide a method of delivering a medicament which comprises the use of a delivery device as hereinbefore described. We especially provide a method of delivering a powder which comprises the use of a powder delivery device as hereinbefore described.

According to a yet further embodiment of the present invention there is provided a method of treatment of a patient with a respiratory disorder which comprises the administration of a medicament using a delivery device as hereinbefore and/or hereinafter described.

According to a still further aspect of the present invention there is provided a method of treatment of a patient with a systemic disorder which comprises the administration of a medicament using a delivery device of the invention.

The invention will now be described by way of example only and with reference to the accompanying drawings in which,

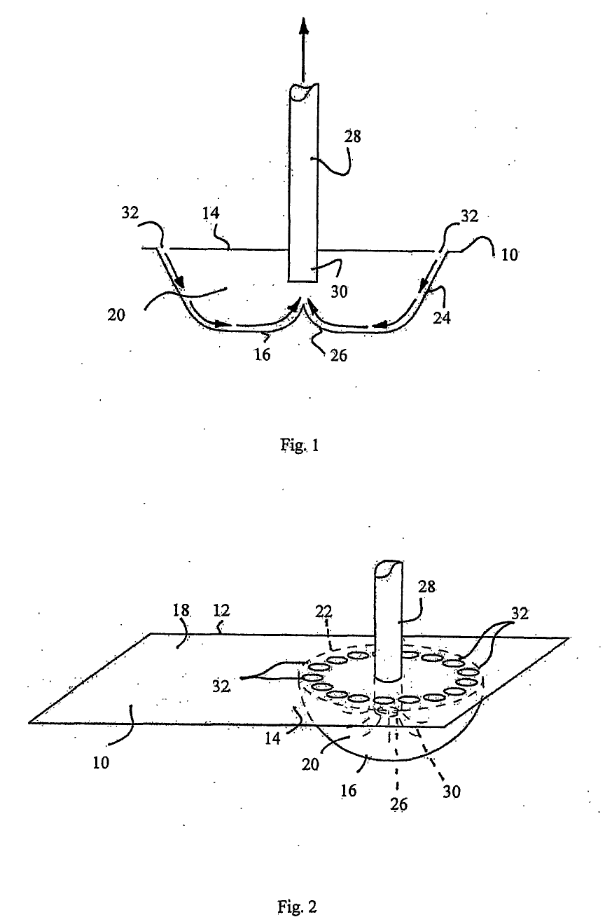

FIGS. 1 and 2 are representations of a prior art system comprising a receptacle with a raised central region;

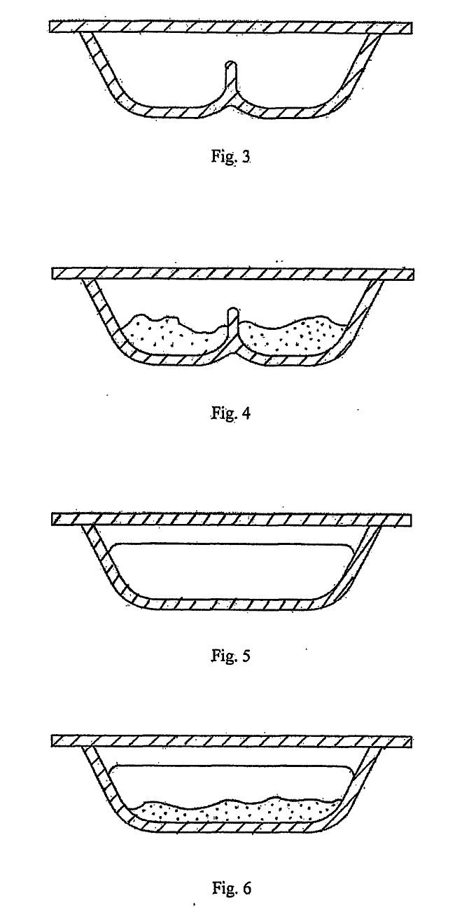

FIG. 3 is a front cross-section of a receptacle of the invention;

FIG. 4 is a front cross-sectional view of a receptacle containing medicament powder;

FIG. 5 is a side cross-section of a receptacle of the invention;

FIG. 6 is a side cross-sectional view of a receptacle containing medicament;

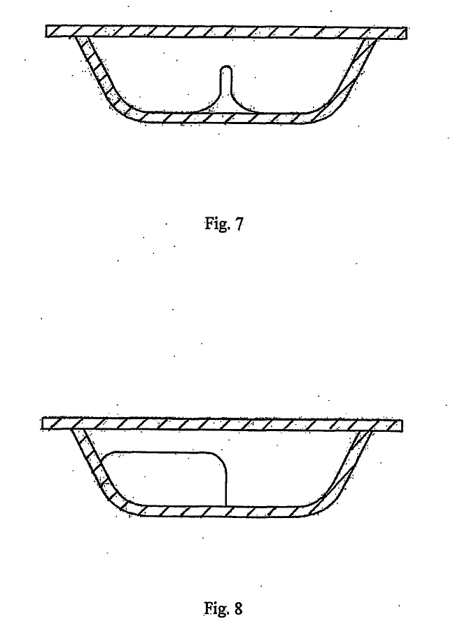

FIG. 7 is a front cross-section of a receptacle comprising a radial ridge;

FIG. 8 is a side cross-sectional view of a receptacle comprising a radial ridge;

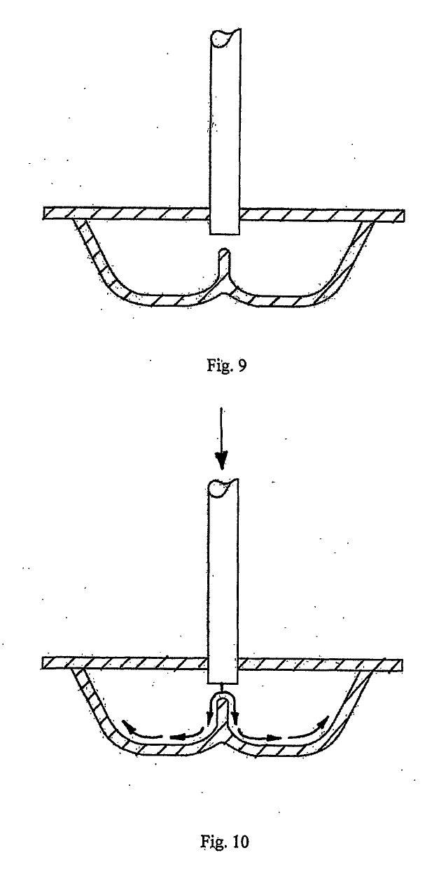

FIG. 9 is a front cross-sectional view of a receptacle with air inlet tube inserted;

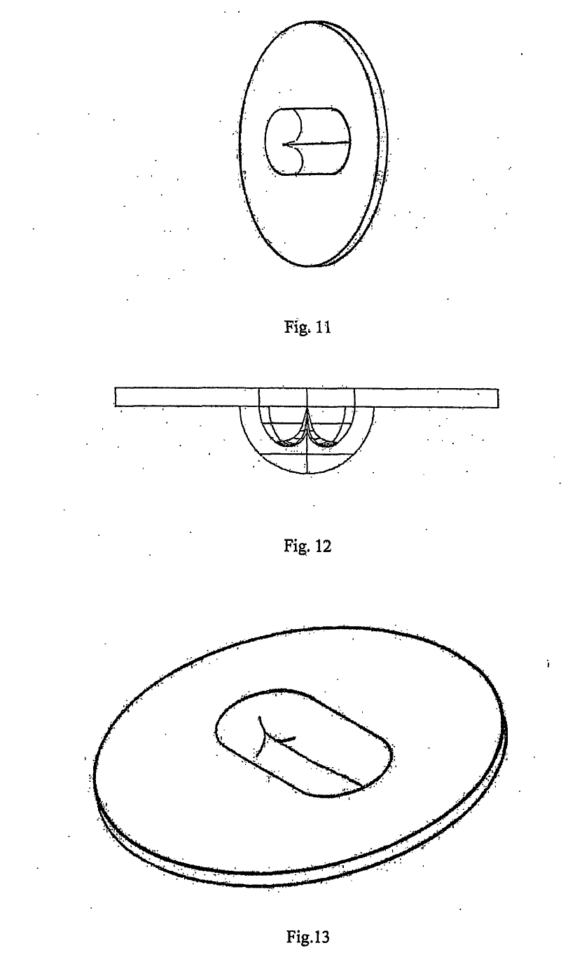

FIG. 10 is a front cross-sectional view of a receptacle of the invention showing air flow;

FIG. 11 is a perspective representation of a receptacle of the invention;

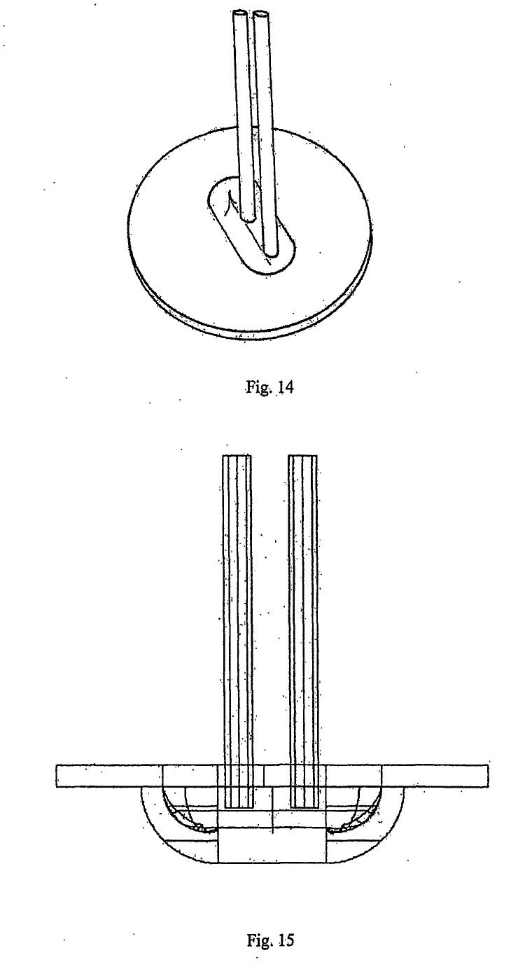

FIG. 12 is a schematic representation;

FIG. 13 is a perspective representation from above;

FIG. 14 is a perspective representation with vent tubes inserted;

FIG. 15 is a schematic representation of FIG. 14;

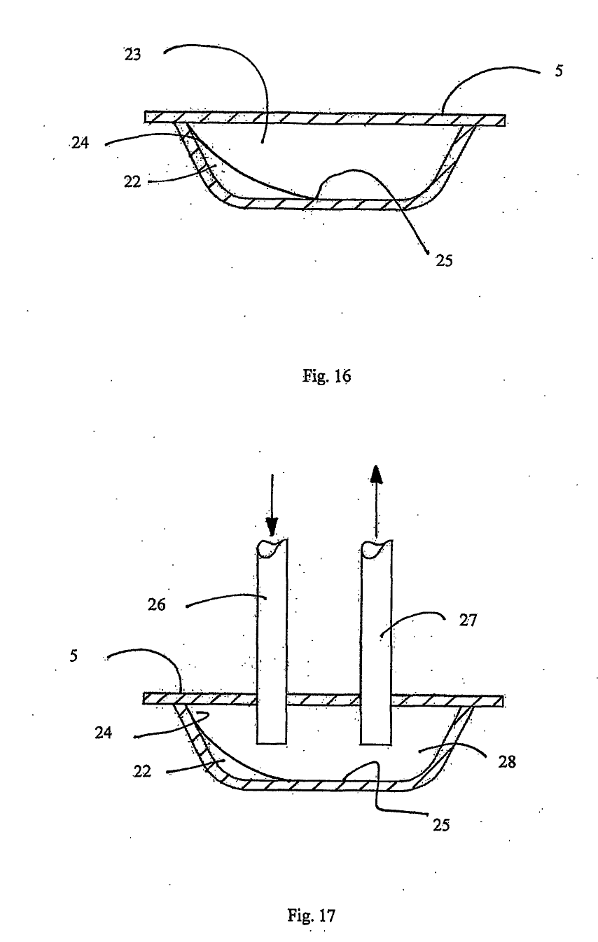

FIG. 16 is a side cross-sectional view of a receptacle comprising a partial radial ridge;

FIG. 17 is a side cross-sectional view of a receptacle comprising a partial radial ridge with inlet and outlet tubes inserted;

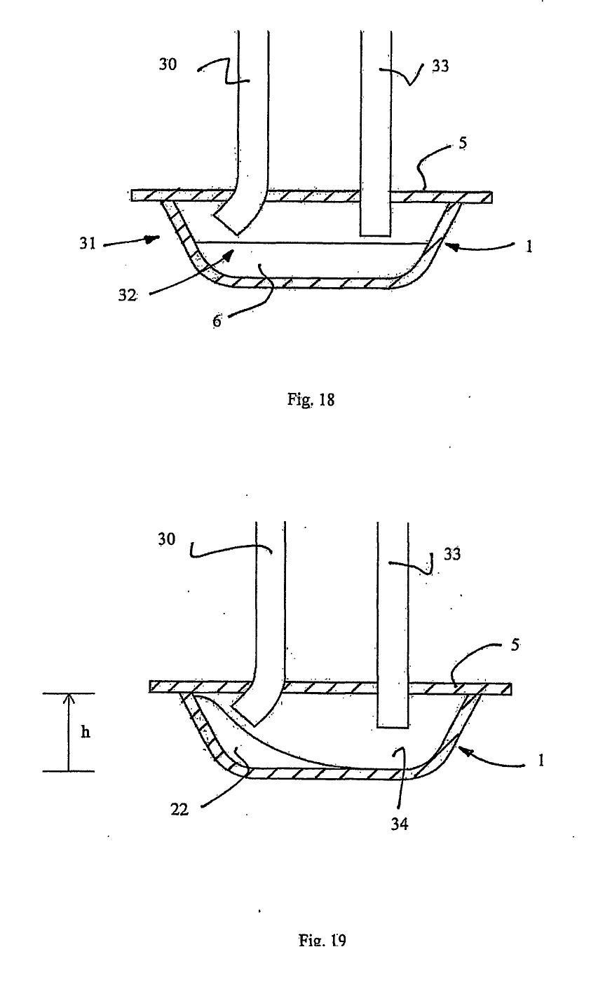

FIG. 18 illustrates a bent inlet tube;

FIG. 19 also illustrates a bent inlet tube;

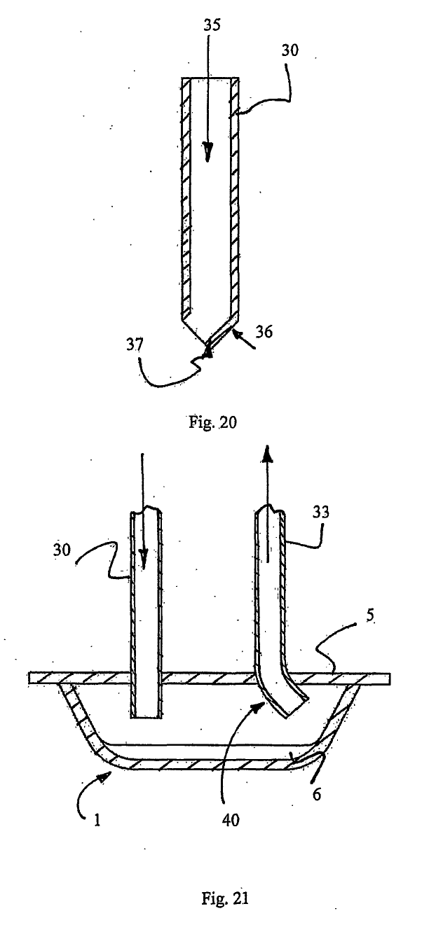

FIG. 20 illustrates how an inlet or extraction tube may be bent;

FIG. 21 illustrates a bent extraction tube; and

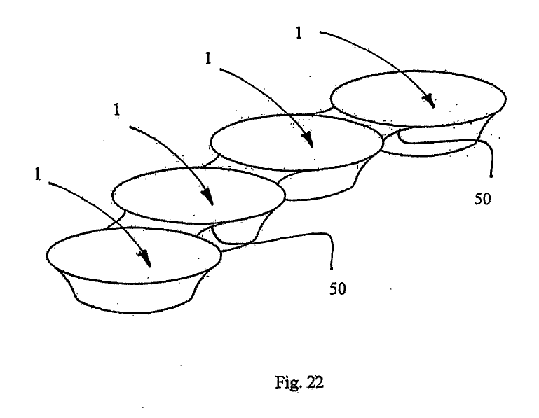

FIG. 22 illustrates a series of receptacles.

Referring to FIGS. 1 and 2, the prior art comprises a receptacle with a raised central region. In use, a powder outlet tube is inserted in the receptacle above the raised central region. Vents (air inlets) are pierced in the foil covering around the periphery of the receptacle. Air flows in through the vents, picking up powder and exits through the central vent tube.

Referring to FIGS. 3 to 6, a receptacle (1) of the invention comprises a container with a base (2) and side walls (3). The end (4) of the side walls (3) distal from the base (2), support a foil cover (5). The base (2) is provided with a raised diametrical ridge (6). The height of the ridge (6) is such that space (7) exists between the top (8) of the ridge (6) and the underside (9) of the cover (5). Medicament powder (10) is provided on the first (13) and second (14) sides of the ridge (6). The ridge (6) essentially divides the receptacle (1) into two separate compartments (11 and 12).

Referring to FIGS. 7 and 8, the ridge (15) comprises a radial element such that only a portion (16) of the receptacle (1) is divided in separate components (17 and 18).

Referring to FIGS. 9 and 10, in use an air inlet conduit (19) is inserted through the cover (5) into the receptacle (1). The inlet (19) rests substantially above the ridge (6). Inlet air (20) is passed through the inlet conduit (19) and upon hitting the ridge (6), the flowing air (20) is divided into two substantially equal parts (20a and 20b). An outlet conduit (not shown) is provided, through which the inlet air and aerosolised powder/medicament escapes.

Referring to FIGS. 14 and 15, the receptacle (1) is shown with air inlet (19) and outlet (21).

Referring to FIG. 16, the ridge (22) comprises a partial radial element such that only a portion (23) of the receptacle (1) is divided in separate compartments. Furthermore, the ridge (22) is arcuate such that the height of the ridge is greater towards the periphery (24) of the receptacle than it is adjacent the middle (25) of the receptacle.

Referring to FIG. 17, an (air) inlet tube (26) is inserted through the cover (5), adjacent the ridge (22), whilst an (powder) outlet tube (27) is inserted adjacent the ridge free portion (28) of the receptacle (1). This aspect of the invention is advantageous in that, inter alia, two vortices are caused along the length of the receptacle.

FIG. 18 illustrates a further embodiment of the present invention in which the inlet tube 30 is bent at a lower region. This lower region forms a piercing portion of the inlet tube as the tube is urged against the foil cover 5 when the medicament stored in the receptacle 1 is to be dispensed. The angle of curvature defining how bent the lower portion of the inlet tube 30 is may be between 0° and 90°. It will be understood that when the angle of curvature is such that piercing of the foil cover may be impeded by the curved outer portion of the tube, a piercing point may be fabricated on the tube or the tube may be fabricated as shown more clearly in FIG. 20.

The curvature at the lower portion of the inlet tube is such that when air or other dispensing gas is produced at the inlet, the air entering the receptacle is directed against the side wall region 31 as well as a portion 32 of the ridge 6. As a result swirl flow of air is induced within the receptacle which helps to entrain medicament in the receptacle drawing it towards the outlet tube 33.

FIG. 19 illustrates a further embodiment of the present invention in which the ridge 22 is an arcuate ridge having a height h above an inner surface 34 of the receptacle which is higher at the edge of the receptacle than elsewhere. As illustrated in FIG. 19 the inlet 30 is curved at a lower portion so that air entering the receptacle is incident upon the side walls and a portion of the ridge 22. This helps create an advantageous air flow within the receptacle which helps gather up medicament located in the receptacle and move it towards the extraction (or outlet) tube 33.

FIG. 20 illustrates how air flow may be directed from a non-axial direction whilst still retaining the piercing ability of either an inlet 30 or outlet 33 tube. Air or other gas is input at the inlet 35 and is directed at an angle away from the axial flow by a bent portion of the tube 30. The bent portion 36 has a piercing tip 37 which helps the tube penetrate the foil or other covering material which seals the receptacle. The bent portion 36 may be aligned at a desired angle so that the air flow inwards to a receptacle during use either flows in a direction towards the base of the receptacle or towards a side wall.

FIG. 21 illustrates a still further embodiment of the present invention in which an outlet tube 33 has a lower region 40 which is bent. In this embodiment the inlet tube 30 is substantially linear so that air input at the inlet is directed substantially at right angles to the base of the receptacle. The inlet tube is directed so that it is over the ridge 6 which helps split the incoming air into two equal portions. Splitting the air in this manner helps conserve momentum of the incoming air as will be understood by those skilled in the art.

It will be understood that according to embodiments of the present invention both or either of the inlet and extraction tubes may be angled at any angle from 0 (in which the lower region of the tube is substantially perpendicular to the base of the receptacle) and 90° (in which the piercing end region of the tube is substantially parallel with the base of the receptacle. It will be understood that the ratio of receptacle diameter to jet diameter (the diameter of the inlet or extraction tube) may be selected to determine characteristics of the air flow within the receptacle.

FIG. 22 illustrates a series of receptacles 1 which are held together by a web 50. The receptacles may be formed from plastics material or may be pressed from a single aluminium sheet. As an alternative independent receptacles may be provided for use in a delivery device as appropriate.

It will be understood that according to embodiments of the present invention the manner in which the inlet and outlet tubes may be bent may be selected to provide desirable air flow in the receptacle during use. In a preferable embodiment the inlet tube is turned towards the outside of the receptacle so that air flow impacts upon that side and is split in two by the ridge. The extraction tube is likewise turned towards an edge region of the receptacle but at 180° to the direction in which the inlet tube is turned. As a result the air path length within the receptacle is maximised. This makes sure that all medication is cleared out of the blister and provides a maximum opportunity for turbulent air flow to interact with medicament particles so as to deagglomerate those particles. As an alternative either or both of the tubes may be turned inwardly towards a central region of the receptacle.

The above specific examples have been described by way of example only. It will be understood that modifications may be made to these without departing from the scope of the present invention.

1. A receptacle for holding a medicament, the receptacle comprising a cavity provided with a raised ridge.

2. A receptacle according to claim 1 characterised in that the raised ridge is adapted to split air flow into two substantially equal portions.

3. A receptacle according to claim 1 characterised in that the raised ridge is traverses the radius of the receptacle.

4. A receptacle according to claims 1 or 3 characterised in that the raised ridge is an arcuate ridge.

5. A receptacle according to claim 1 characterised in that the ridge traverses a region of the receptacle without contacting the walls of the receptacle.

6. A receptacle according to claim 1 characterised in that the ridge is substantially diametrical.

7. A receptacle according to claim 1 characterised in that the height of the ridge is such that the ridge extends substantially to the top of the receptacle.

8. A receptacle according to claim 1 characterised in that the upper surface of the ridge lies below the top of the receptacle.

9. A receptacle according to claim 1 characterised in that a frangible sealing member is fixed to the upper part of the receptacle.

10. A receptacle according to claim 9 characterised in that the frangible sealing member comprises a material which is substantially impermeable to moisture and/or is moisture resistant.

11. A receptacle according to claim 10 characterised in that the frangible sealing member comprises a plastics film or foil.

12. A receptacle according to claim 11 characterised in that the frangible sealing member comprises an aluminium foil material.

13. A receptacle according to claim 11 characterised in that the frangible sealing member comprises a plastics material that is heat bonded to the receptacle.

14. A receptacle according to claim 11 characterised in that the frangible sealing member comprises a foil material that is bonded to the receptacle with an adhesive.

15. A receptacle according to claim 1 characterised in that a plurality of dosage units is arranged in series.

16. A cartridge or strip comprising a series of receptacles according to claim 15.

17. A delivery device which comprises a receptacle according to claim 1.

18. A delivery device according to claim 17 characterised in that the device comprises a housing having a holder that is adapted to receive the receptacle.

19. A delivery device according to claim 17 characterised in that the delivery device includes means for rupturing a frangible cover.

20. A delivery device according to claim 19 characterised in that the rupturing means comprises a piercing mechanism that is adapted to pierce one or more holes in the cover.

21. A delivery device according to claim 17 characterised in that the delivery device also includes an air inlet tube.

22. A delivery device according to claim 17 characterised in that it also includes an extraction tube.

23. A delivery device according to claim 21 characterised in that the extraction tube and/or the air inlet acts as the piercing member.

24. A delivery device according to claim 20 characterised in that a separate piercing member and a separate extraction tube are provided.

25. A delivery device according to claim 1 characterised in that in use the extraction tube is positioned above the ridge.

26. The delivery device according to any one of claims 21 to 25 wherein a piercing end region of said inlet tube and/or said extraction tube is bent.

27. The delivery device according to claim 26 wherein said inlet tube is bent to point at least partly away from a central zone of a receptacle received by said delivery device.

28. The delivery device according to claim 27 wherein said inlet tube is bent so as to induce swirl flow of air and medicament in said receptacle.

29. The delivery device according to claim 26 wherein said inlet tube is bent to point at least partly towards a central zone of a receptacle received by said delivery device.

30. The delivery device according to claim 29 wherein said inlet tube is bent to cause air flow to be split at an angle in the direction of the extraction tube.

31. The delivery device according to any one of claims 26 to 30 wherein an angle of curvature of the bent portion of the inlet tube is between 1 and 90°.

32. The delivery device according to claim 26 wherein a piercing end region of said extraction tube is bent either towards or away from a central zone of a receptacle received by said delivery device.

33. A delivery device according to claim 17 characterised in that the device is a powder delivery device.

34. A delivery device according to claim 17 characterised in that the delivery device is an inhaler.

35. A delivery device according to claim 34 characterised in that the inhaler is a dry powder inhaler.

36. A delivery device according to claim 34 characterised in that the inhaler comprises a plurality of medicament receptacles.

37. A delivery device according to claim 36 characterised in that each receptacle houses two medicaments.

38. A delivery device according to claim 37 characterised in that each medicament is held at either side of the ridge.

39. A delivery device according to claim 17 characterised in that the device is provided with suitable indexing means.

40. A receptacle according to claim 1 characterised in that the medicament is a powder.

41. A receptacle according to claim 40 characterised in that the powder is selected from the group of drugs for the treatment of asthma, COPD or respiratory infections such as β₂-agonists, e.g. fenoterol, formoterol, pirbuterol, reproterol, rimiterol, salbutamol, salmeterol and terbutaline; non-selective beta-stimulants such as isoprenaline; xanthine bronchodilators, e.g. theophylline, aminophylline and choline theophyllinate; anticholinergics, e.g. ipratropium bromide; mast cell stabilisers, e.g. sodium cromoglycate and ketotifen; bronchial anti-inflammatory agents, e.g. nedocromil sodium; and steroids, e.g. beclomethasone dipropionate, fluticasone, budesonide, flunisolide and ciclesonide, and isomers and/or salts or derivatives thereof.

42. A receptacle according to claim 41 characterised in that receptacle comprises a combination of medicaments, selected from steroids, such as, beclomethasone dipropionate and formoterol; beclomethasone dipropionate and salmeterol; fluticasone and formoterol; fluticasone and salmeterol; budesonide and formoterol; budesonide and salmeterol; flunisolide and formoterol; and flunisolide and salmeterol.

43. A receptacle according to claim 40 characterised in that the receptacle comprises a systemically active materials, such as, proteinaceous compounds and/or macromolecules, for example, hormones and mediators, such as insulin, human growth hormone, leuprolide and alpha interferon; growth factors, anticoagulants, immunomodulators, cytokines and nucleic acids.

44. A method of delivering a medicament which comprises the use of a delivery device according to claim 17.

45. A method according to claim 44 characterised in that the medicament is a powder.

46. A method of treatment of a patient with a respiratory disorder which comprises the administration of a medicament using a delivery device according to claim 17.

47. A method according to claim 46 characterised in that the medicament is a powder.

48. A method of treatment of a patient with a systemic disorder which comprises the administration of a medicament using a delivery device according to claim 17.

49. A method of delivering a powder which comprises the use of a delivery device according to claim 17.

50. A receptacle or a delivery device substantially as described with reference to the accompanying drawings.
